(19) United States
(12) Patent Application Publication
(10) Pub. No.: US 2022/0417367 A1
(43) Pub. Date: Dec. 29, 2022

(54) MULTIFUNCTION DEVICE

(71) Applicant: TOSHIBA TEC KABUSHIKI KAISHA, Tokyo (JP)

(72) Inventors: Katsunori SUZUKI, Mishima Shizuoka (JP); Takeshi Yasuda, Yokohama Kanagawa (JP); Nobuyuki Uchikawa, Ito Shizuoka (JP)

(21) Appl. No.: 17/692,652

(22) Filed: Mar. 11, 2022

(30) Foreign Application Priority Data
Jun. 23, 2021 (JP) 2021-104120

(51) Int. Cl. H04N 1/00; H04N 1/44

(52) U.S. Cl. CPC H04N 1/00076; H04N 1/00477; H04N 1/4413; H04N 1/00244

(57) ABSTRACT

According to an embodiment, it is possible to restrict usage of a web-based service error resolution service by multifunctional peripheral devices or the like. A multifunction device for such purposes includes a display unit with a display screen, a device unit configured to generate an error code when an error in the device unit occurs, and a processor. The processor configured to acquire the error code from the device unit and transmit an error notification including the error code to an external apparatus. The processor then receives a counted number of errors from the external apparatus, and then select an error resolution screen to be displayed on the display screen based on the received counted number of errors.

### CROSS-REFERENCE TO RELATED APPLICATION

This application is based upon and claims the benefit of priority from Japanese Patent Application No. 2021-104120, filed Jun. 23, 2021, the entire contents of which are incorporated herein by reference.

### FIELD

Certain embodiments described herein relate to a multifunction device such as multifunctional peripheral device incorporating various functions such as printing, copying, and scanning.

### BACKGROUND

Some multifunction devices are provided with means for providing user guidance via a web-based service when an error occurs. However, such web-based guidance is not necessarily required every time an error occurs. In some instances, it may be desirable to limit or prevent use of the web-based guidance service.

### BRIEF DESCRIPTION OF THE DRAWINGS

FIG. 1 is a block diagram of a multifunction device according to an exemplary embodiment.

FIG. 2 is a diagram schematically showing a data structure of a data record in a management data table.

FIG. 3 is a diagram schematically showing a data structure of a setting file.

FIG. 4 is a block diagram of an error treatment system incorporating a multifunction device.

FIG. 5 is a flowchart of error processing.

FIG. 6 is a flowchart of the error processing.

FIG. 7 is a diagram showing an example of a first error screen.

FIG. 8 is a diagram showing an example of a guidance screen.

FIG. 9 is a diagram showing an example of a second error screen.

### DETAILED DESCRIPTION

In general, according to at least one embodiment, an improvement to a multifunction device permitting the restricting and/or limiting of web-based guidance services is provided.

According to one embodiment, a multifunction device includes a display unit with a display screen, a device unit configured to generate an error code when an error in the device unit occurs, and a processor. The processor configured to acquire the error code from the device unit and transmit an error notification including the error code to an external apparatus. The processor then receives a counted number of errors from the external apparatus, and then select an error resolution screen to be displayed on the display screen based on the received counted number of errors.

An example embodiment will be described with reference to the drawings.

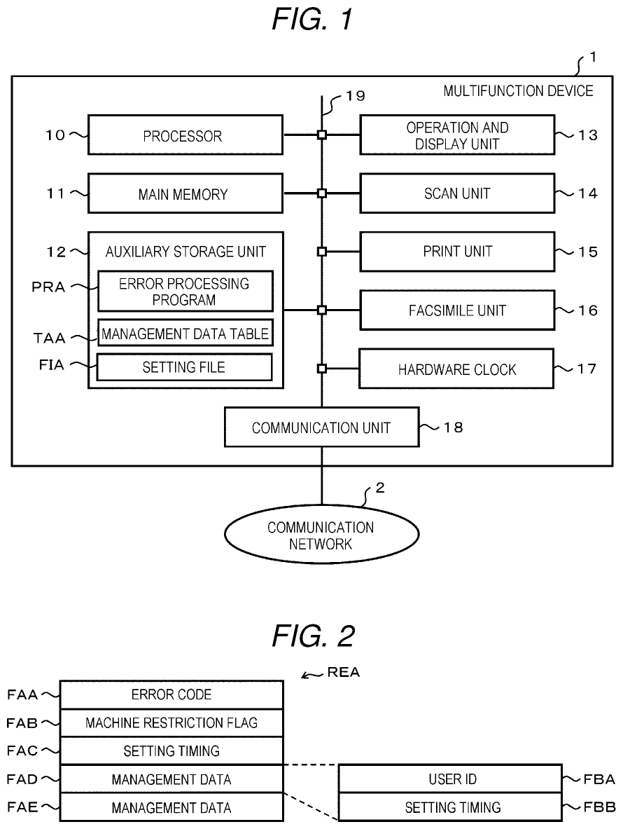

FIG. 1 is a block diagram of a multifunction device 1 according to the present example embodiment.

The multifunction device 1 has multiple functions. For example, the multifunction device 1 is a multifunctional peripheral device which can function as a copier, a scanner, a printer, a facsimile machine, and the like. However, it is not necessary for every embodiment to provide all of these functions, and other functions may be provided in addition to or instead of the listed functions. The multifunction device can also be referred to as a multi-function peripheral (MFP) in some instances.

The multifunction device 1 includes a processor 10, a main memory 11, an auxiliary storage unit 12, an operation and display unit 13 (referred to below as “control panel 13”), a scan unit 14, a print unit 15, a facsimile unit 16, a hardware clock 17, a communication unit 18, a transmission line 19, and the like. The processor 10, the main memory 11, the auxiliary storage unit 12, the control panel 13, the scan unit 14, the print unit 15, the facsimile unit 16, the hardware clock 17 and the communication unit 18 are connected via the transmission line 19. The scan unit 14, the print unit 15, and the facsimile unit 16 are examples of device units or sub-units of the multifunction device 1. In some examples, the multifunction device 1 may include fewer, more and/or different device units than those of the present example.

The processor 10, the main memory 11, and the auxiliary storage unit 12 are connected by the transmission line 19 in this example so as to form a computer that performs information processing.

The processor 10 executes the information processing in accordance with an information processing program such as an operating system, middleware, and/or an application program.

The main memory 11 includes a nonvolatile memory area and a volatile memory area. The main memory 11 stores the information processing program in the nonvolatile memory area. In addition, the main memory 11 may store data necessary for the processor 10 to execute processing for controlling each unit. The main memory 11 provides the volatile memory area as a work area in which data can be rewritten by the processor 10.

As the auxiliary storage unit 12, for example, known storage devices such as an electric erasable programmable read-only memory (EEPROM), a hard disk drive (HDD), and a solid-state drive (SSD) can be used alone or in combination. The auxiliary storage unit 12 stores data used when the processor 10 performs various types of processing and also data generated by the processing by the processor 10. The auxiliary storage unit 12 stores information processing programs. One of information processing programs stored in the auxiliary storage unit 12 can be an error processing program PRA. The error processing program PRA provides programs and algorithms for error processing functions to be described further below. The error processing program PRA may be implemented as an independent application program or may be implemented as a program module (e.g., subroutine) of an information processing program for overall operational control of the multifunction device 1. A part of a storage area of the auxiliary storage unit 12 is used to store a management data table TAA and a setting file FIA.

The control panel 13 receives an input operation from the user of the multifunction device 1 and displays various types of information to the user. The control panel 13 may incorporate various input devices and display devices such as, a touch panel, a keyboard, a switch, a button, a key, a LED lamp, or a liquid crystal display panel.

The scan unit 14 reads a document and generates image data from the document.

The print unit 15 prints an image corresponding to image data on a recording sheet. The print unit 15 includes a well-known printing device such as an electrophotographic image forming unit.

The facsimile unit 16 performs various well-known processing for performing communication in accordance with a facsimile standard via a communication network such as a public switched telephone network (PSTN).

The hardware clock 17 always performs a clock operation and outputs date and time information. In the present embodiment, the date and time information represents at least a month, a date, an hour, and a minute. However, either one or both of a year and a second may also be represented. The hardware clock 17 may be replaced in some exampled by a system clock managed by the operating system.

The communication unit 18 executes processing for performing data communication via the communication network 2. As the communication unit 18, for example, an existing communication device for LAN can be used.

The transmission line 19 includes an address bus, a data bus, a control signal line, and the like, and transmits data and control signals between the connected units.

FIG. 2 is a diagram schematically showing a data structure for data records REA included in the management data table TAA.

The management data table TAA is a set of the data records REA associated with a plurality of error codes, respectively. The error code is a predetermined identifier for identifying an error type that might be detected in the multifunction device 1.

The data records REA include fields FAA, FAB, and FAC. The data records REA may include one or more fields after a field FAD.

An associated error code is set in the field FAA. The field FAB is set with a machine restriction flag indicating whether to restrict the execution of a guidance operation, which will be described later, in response to an occurrence of an error identified by the associated error code. In the present example, it is assumed that the machine restriction flag is set to indicate a restricted state when the flag is a positive value (non-zero value). In the field FAC, when the execution of the guidance operation has been restricted, data representing a setting time of the restriction is set. The setting time is assumed to be, for example, data representing the date and time at which the restriction was started. More specifically, the setting time is assumed to be data representing a month, day, hour, and minute. However, the setting time may be data further representing another piece of information such as year or second, or may be data not representing some pieces of information such as hour and minute. The data used as the setting time is not limited to the data directly indicating the setting time, and may be any data as long as the setting time can be specified therefrom, for example, an elapsed time from the initial setting time may be used.

When the execution of the guidance operation in response to the occurrence of an error (as identified by the associated error code) is restricted according to user, management data for each user can be set in a field (or fields) after the field FAD. Therefore, if the execution of the guidance operation has not been restricted by user, the fields after the field FAD are not necessarily included in the data records REA.

When the execution of the guidance operation has been restricted according to user, one or more fields in which the management data associated with each of the particular users to be restricted can be set in the fields after the field FAD. The management data includes a field FBA and a field FBB. A user ID (identifier) is set in the field FBA. In the field FBB, the data representing the setting time of the restriction of the guidance operation for the associated user is set. The data in the field FBB may also be the same data as the data set in the field FAC.

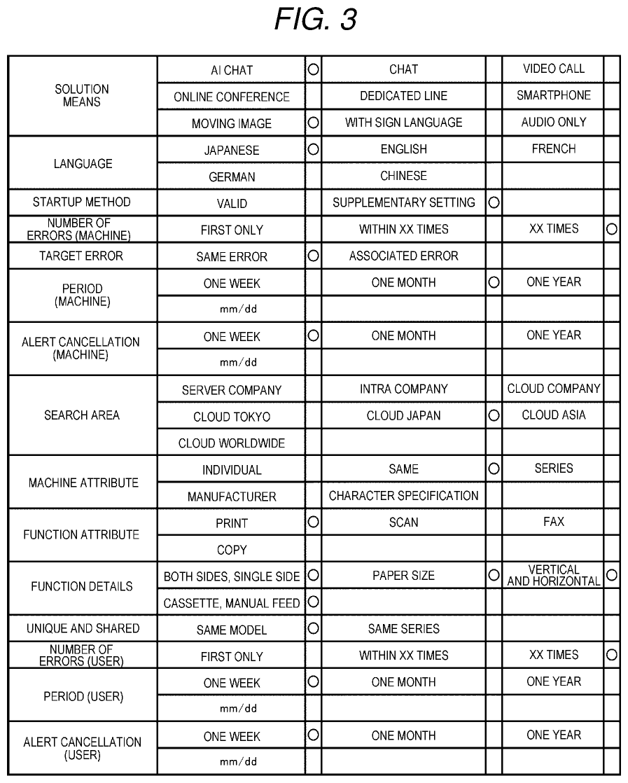

FIG. 3 is a diagram schematically showing an example of a data structure of a setting file FIA.

The setting file FIA is a data file indicating validity and invalidity for each of a plurality of the setting items to which a plurality of predetermined classification items belong.

The setting file FIA of the example shown in FIG. 3 includes entries/fields “solution means”, “language”, “startup method”, “number of errors (machine)”, “target error”, “period (machine)”, “alert cancellation (machine)”, “search area”, “machine attribute”, “function attribute”, “function details”, “unique and shared”, “number of errors (user)”, “period (user)” and “alert cancellation (user)” as the classification items.

For example, the “solution means” includes the setting item related to a method of the guidance operation. In the present example, the “solution means” classification includes “AI chat”, “chat”, “video call”, “online conference”, “dedicated line”, “smartphone”, “moving image”, “with sign language” and “audio only” as the potential setting items. Among these, “AI chat” represents a question answering function by a computer chat (e.g., “chatbot”) using an artificial intelligence (AI). The “moving image” item indicates a playback or playing of a moving image or pre-recorded video for guiding a resolving method for an error.

In the example shown in FIG. 3 an open circle in a column directly after the setting item indicates the corresponding setting item is set as valid. That is, in the example shown in FIG. 3, among the listed “solution means” the “AI chat” and the “moving image” are set to be usable for the guidance operation.

The classification items and the setting items shown in FIG. 3 are examples, and may be arbitrarily selected by, for example, a designer of the multifunction device 1 or a creator of the error processing program PRA. Similarly, setting of the validity and invalidity of each setting item may be set, reset, or adjust by, for example, an administrator of the multifunction device 1.

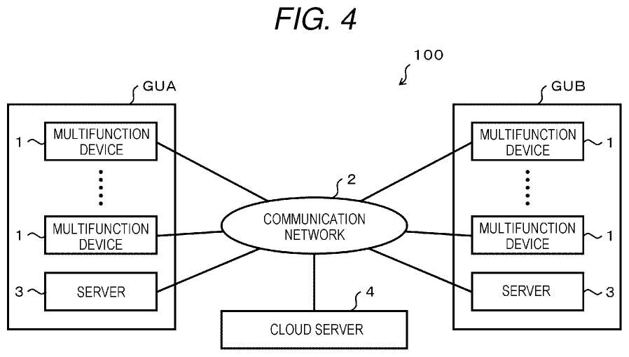

FIG. 4 is a block diagram showing a configuration of an error treatment system 100 configured using the multifunction device 1.

The error treatment system 100 includes a large number of multifunction devices 1. Each multifunction device 1 belongs to one of a plurality of groups such as a group GUA and a group GUB. The multifunction device 1 belonging to the group GUA or the group GUB can communicate with a server 3 belonging to the same respective group via a communication network 2. A server 3 belonging to each group can communicate with a cloud server 4 via the communication network 2. The groups such as the group GUA and the group GUB can be set by, for example, office or company, but, in general, any grouping of devices can be used.

As the communication network 2, the Internet, a virtual private network (VPN), a local area network (LAN), a public communication network, a mobile communication network, or the like may be used alone or in combination as appropriate. As an example, a LAN, a VPN, and the Internet are used as the communication network 2. The LAN or the VPN can be applied to the communication between the multifunction device 1 and the server 3 belonging to the same group. The Internet can be used for communication between the multifunction devices 1 and the server 3 and the cloud server 4.

The server 3 performs the information processing for managing the multifunction devices 1 belonging to the same group. In the present example, the server 3 receives error notifications from the multifunction devices 1 from the same group, and monitors the occurrence and handling of errors in these multifunction devices 1.

The cloud server 4 performs the information processing for providing the web service(s) for guiding the correction and/or clearance of an error to a multifunction device 1.

Although the large number of multifunction devices 1 included in the error treatment system 100 have a configuration as shown in FIG. 1 as a schematic configuration, the multifunction devices generally do not have exactly the same configuration. For example, the multifunction devices 1 may be a mixture of several different models and types. The multifunction devices 1 may have the same manufacturer or different manufacturers.

Next, the operation of the multifunction device 1 configured as described above will be described. The specific content of the processing described below is merely an example, and it is possible to appropriately change the order of some of the processing, omit some of the processing, add another processing, and the like.

The multifunction device 1 operates to function as a copier, a scanner, a printer, a facsimile machine, and the like. When an error of the multifunction device 1 occurs in the scan unit 14, the print unit 15, or the facsimile unit 16, a cause may be identified and the corresponding error code is determined. The operation for monitoring the errors may be at the unit level rather than at the overall multifunction device 1 level. That is, the scan unit 14, the print unit 15, and the facsimile unit 16 may function as a detection unit configured to detect the errors within the unit itself.

After an error is detected, the processor 10 starts the execution of the error information processing (hereinafter, referred to as the error processing) according to the error processing program PRA.

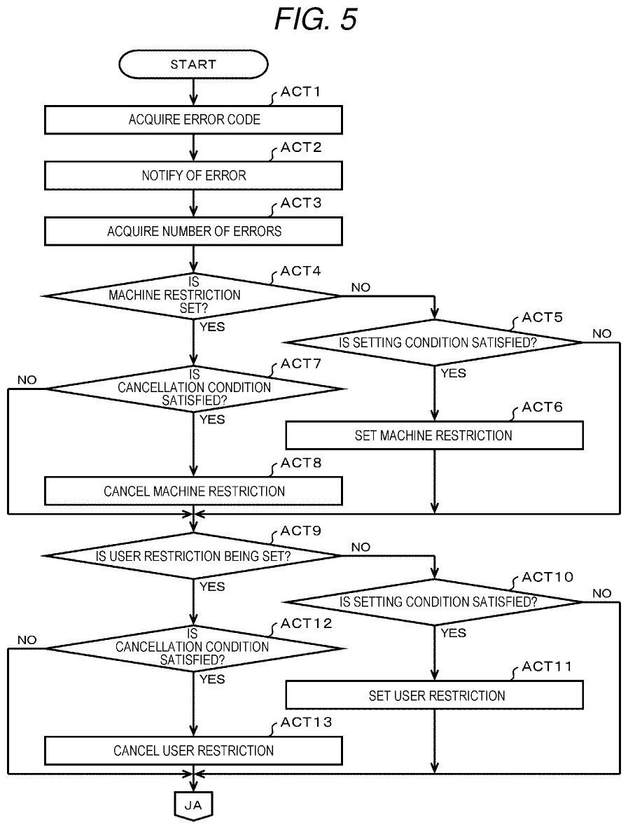

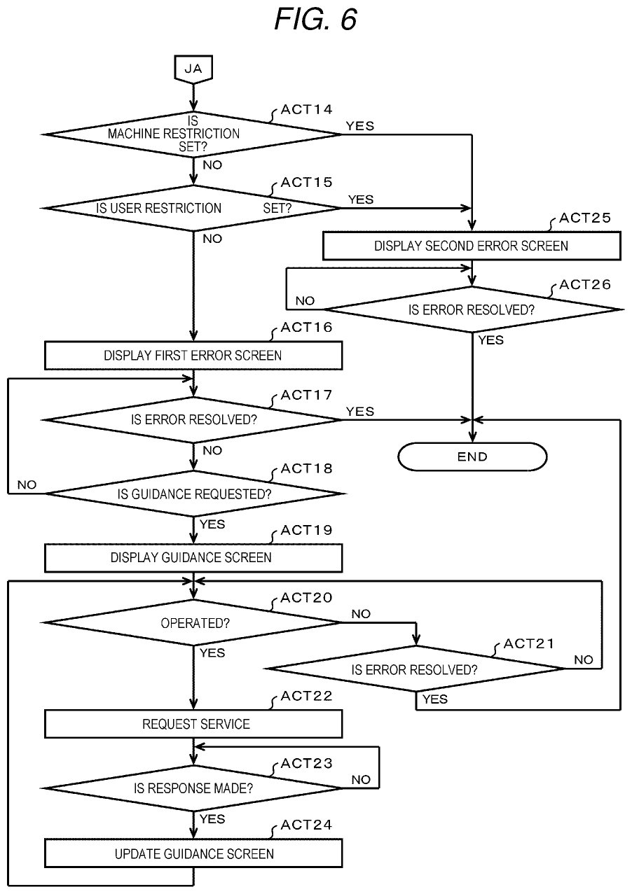

FIGS. 5 and 6 are flowcharts of the error processing.

In ACT 1 in FIG. 5, the processor 10 acquires the error code of the detected error from the unit in which the error was detected.

In ACT 2, the processor 10 notifies a predetermined notification destination of the detected error. Usually, the server 3 within the same group as the multifunction device 1 with the detected error is used as the notification destination. The notification includes a machine code (machine ID) for the multifunction device 1 reporting the error. The machine ID specifies the reporting multifunction device 1 from the other multifunction devices 1. The notification also includes the error code acquired in ACT 1 and other data indicating an occurrence time of the error. The data representing the occurrence time is, for example, data representing a year, month, day, hour, minute, second or the like.

When the user requests login for executing a print job or other task (a “job”) at or with the multifunction device 1, the processor 10 acquires a user ID from the user and performs user authentication. The processing for the user authentication may be the same as various know processing methods. Thus, the processor (or, more broadly, the computer, device, or controller incorporating processor 10) functions as an identification unit to identify the user.

Then, the processor 10 may include the user ID of a logged-in user who happens to be logged in when an error occurs in the notification of the detected error.

In addition, the processor 10 includes the various setting values, device details, or operating parameters included in the setting file FIA in the notification. For example, the processor 10 supplies a setting value related to the “target error”, the “period (machine)”, the “search area”, the “machine attribute”, the “function attribute”, and/or the “period (user)”.

In addition, the processor 10 indicates an application state in the job during which the error occurred with respect to the setting related to the “function details”.

For example, for the multifunction device 1 whose machine code is “AAAAA”, an error whose error code is “BBBBB” occurs at 9:00:00 on Jan. 1, 2021, and the user ID of the user who is logged in at that time is “CCCCC”. Further, it is assumed that when the error (error code “BBBBB”) occurs the setting file FIA is in the state shown in FIG. 3. It is further assumed that the job involved single-sided printing, A4 size paper, vertical direction printing, and cassette paper feeding. In this case, the processor 10 generates notification data such as “machine code=AAAAA, error code=BBBBB, occurrence timing=2021.01.01.09:00:00, user ID=CCCCC, target error=same error, period (machine)=1 month, search area=cloud Japan, machine attribute=same, function attribute=print, function details=single side/A4/vertical direction/cassette, period (user)=1 week”, and sends the notification data to the communication network 2 from the communication unit 18 to the server 3 as the notification destination, thereby performing a notification.

When receiving the notification of the error, the server 3 updates a history database for managing a history of the error in the multifunction devices 1 in the group so as to reflect contents of the notification.

When receiving the notification of the error, the server 3 requests the cloud server 4 to provide the number of errors. At a time of this request, the server 3 sends the data received from the multifunction device 1 to the cloud server 4. However, the server 3 may exclude a part of the data received from the multifunction device 1, such as data related to the occurrence time, from the data to be sent to the cloud server 4. Alternatively, the server 3 may add additional data such as the identifier for identifying the server 3 itself 3.

The cloud server 4 collects the data in the history database from all the servers 3. The specific timing and the method for the cloud server 4 to collect the data from the various servers 3 is optional.

After receiving a request from the server 3, the cloud server 4 counts the number of errors in the history database that match conditions in the data sent from the server 3. When the notification data of the above specific example is transmitted from the multifunction device 1 to the server 3 then from the server 3 to the cloud server 4, the cloud server 4 counts the number of past errors that match one or more of the following conditions:
The error code is BBBBB.
Generated within the last month (recent time period).
Generated in multifunction devices 1 in Japan (geographic region).
Generated in multifunction devices 1 having the same machine attributes as that of the multifunction device 1 for which the machine code is AAAAA.
Generated with respect to a print function.
Generated in a job involving single-sided printing, A4 size paper, vertical direction and the cassette paper feeding.

The number of corresponding errors is counted in this example without being distinguished by user. Therefore, the counted number of errors without regard to user is thus referred to as the number of common errors.

If the user ID is notified from the server 3, the cloud server 4 may add the following condition to the above conditions:
Generated while the user ID was logged-in to the multifunction device 1.
   The number of errors related to one particular user can be separately counted based on conditions according to categories such as “period (user)” or the like. For example, changing the setting value in the category “period (user)” from, “generated in the last month” to “generated in the last week” permits the counted errors by user ID to use a different time period than the counted errors by machine ID (category: “period (machine)”. The number of errors counted by user ID is referred to as the number of user errors.

Then, the cloud server 4 sends the server 3 the counted number of common errors. When the number of user errors are also counted, the cloud server 4 can also send the server 3 the counted number of user errors. The server 3 notifies the multifunction device 1 (the error source) that triggered the request to the cloud server 4 of the counted number of errors sent from the cloud server 4.

In some examples, the request for the number of errors may be directly sent from the multifunction device 1 to the cloud server 4. In addition, the counted number of errors may be directly sent from the cloud server 4 to the multifunction device 1.

In ACT 3 of FIG. 5, the processor 10 acquires the number of errors as described above. That is, the processor 10 acquires the number of common errors from the server 3. The processor 10 may also acquire the number of user errors from the server 3.

In ACT 4, the processor 10 checks whether a machine restriction has been set with respect to the error identified by the error code acquired in ACT 1. Here, a machine restriction restricts the use of the guidance using the web service by particular multifunction device(s) 1 without reference to any particular user. The processor 10 searches for the data record REA in which the error code acquired in ACT 1 has been set in the field FAA from the management data table TAA, for example. If the machine restriction flag set in the field FAB of the data record REA is in a reset state (“0”), for example, the processor 10 determines NO (the machine restriction is not set), and proceeds to ACT 5.

In ACT 5, the processor 10 checks whether a setting condition for imposing a machine restriction is satisfied. For example, the processor 10 checks whether the number of common errors acquired in ACT 3 matches a condition corresponding to the setting item, which is valid with respect to the classification item referred to as the “number of errors (machine)” in the setting file FIA. For example, if “first only” is set as the “number of errors (machine)”, the processor 10 determines that the setting condition of the machine restriction is satisfied when the number of common errors is “0”. That is, if the number of common errors is “0”, it is assumed that a current error is a first error, and the processor 10 determines that the error matches the condition of “first only”. For example, if “within XX times” is set as the “number of errors (machine)”, the processor 10 determines that the setting condition of the machine restriction is satisfied when the number of common errors is equal to or less than a predetermined threshold value (“XX”). For example, if “XX times” is set as the “number of errors (machine)”, the processor 10 determines that the setting condition of the machine restriction is satisfied when the number of common errors matches the predetermined threshold value “XX”. Then, if it is determined that the setting condition is satisfied, the processor 10 determines YES and proceeds to ACT 6.

In ACT 6, the processor 10 sets the machine restriction related to the current error. For example, the processor 10 changes the machine restriction flag set in the field FAB of the data record REA searched in ACT 4 to the set state. In addition, the processor 10 sets the date and time information output by the hardware clock 17 in the field FAC of the data record REA searched in ACT 4, for example.

On the other hand, when the processor 10 proceeds to ACT 4 if the machine restriction is in the set state, the processor 10 confirms that the machine restriction flag in which the error code acquired in ACT 1 is set in the field FAB of the data record REA set in the field FAA is in the set state, and determines YES since the machine restriction has been set and proceeds to ACT 7.

In ACT 7, the processor 10 checks whether a cancellation condition for the machine restriction is satisfied. The processor 10 checks whether a period corresponding to the setting item, which is valid for the classification item referred to as “period (machine)” in the setting file FIA, is elapsed. For example, if the setting item referred to as “one week” is presently set as the “period (machine)”, the processor 10 determines that the cancellation condition of the machine restriction is satisfied if the date and time from the hardware clock 17 is later than one week after the date and time set as the initial setting time in the field FAC of the data record REA searched in ACT 4. For example, if “one month” is set as the “period (machine)”, the processor 10 determines that the cancellation condition of the machine restriction is satisfied when the date and time output by the hardware clock 17 is later than one month after the date and time set as the initial setting time in the field FAC of the data record REA searched in ACT 4. For example, if “one year” is set as the “period (machine)”, the processor 10 determines that the cancellation condition of the machine restriction is satisfied when the date and time output by the hardware clock 17 is later than one year after the date and time set as the initial setting time in the field FAC of the data record REA searched in ACT 4. For example, if “mm/dd” is set as the “period (machine)”, the processor 10 determines that the cancellation condition of the machine restriction is satisfied when the date and time output by the hardware clock 17 is later than the date and time represented as “mm/dd”, where “mm” is a value from “1” to “12” and “dd” is a value from “1” to “31”. If it is determined that the cancellation condition has been satisfied, the processor 10 determines YES and proceeds to ACT 8.

In ACT 8, the processor 10 cancels the machine restriction related to the current error. For example, the processor 10 changes the machine restriction flag set in the field FAB of the data record REA searched in ACT 4 to the reset state. Further, the processor 10 sets a predetermined null value in the field FAC for the data record REA searched in ACT 4, for example. However, the processor 10 may leave the field FAC unchanged or may leave it blank.

After the machine restriction is set in ACT 6, or after the machine restriction is cancelled in ACT 8, the processor 10 proceeds to ACT 9 in either case. If the processor 10 determines NO in ACT 5 when the setting condition of the machine restriction is not satisfied, the processor 10 passes ACT 6 and proceeds to ACT 9. If the processor 10 determines NO in ACT 7 when the cancellation condition of the machine restriction is not satisfied, the processor 10 passes ACT 8 and proceeds to ACT 9.

In ACT 9, the processor 10 checks whether a user restriction has been set with respect to the error identified by the error code acquired in ACT 1. Here, the user restriction is to restrict the use of the web-service guidance by particular users according to logged-in user ID. Therefore, the processor 10 typically determines that the user restriction is not set if the present user is not logged in. If the present user has logged in and the user ID is acquired, the processor 10 searches for the data record REA in which the error code acquired in ACT 1 is set in the field FAA from the management data table TAA, for example. Next, the processor 10 confirms whether the management data including the field FBA in which the user ID of the logged-in user is set is set after the field FAD of the data record REA. Then, if the corresponding management data does not exist, the processor 10 determines that the user restriction is not set. If the processor 10 determines that the user restriction is not set, the processor 10 determines NO in ACT 9 and proceeds to ACT 10.

In ACT 10, the processor 10 checks whether a setting condition for imposing the user restriction is satisfied. For example, the processor 10 acquires the number of user errors in ACT 3, and checks whether the number of user errors matches the set value for “number of errors (user)” in the setting file FIA. Specific processing of this confirmation may be substantially similar to the processing illustrated in ACT 5, for example. If it is determined that the setting condition for the user restriction is satisfied, the processor 10 determines YES and proceeds to ACT 11.

In ACT 11, the processor 10 sets the user restriction related to the current error. For example, the processor 10 adds a new field in which new management data is set to the rear of a tail field of the data record REA searched in ACT 4. The processor 10 sets the user ID of the logged-in user in the field FBA of the new management data. The processor 10 sets the date and time information output by the hardware clock 17 in the field FBB of the new management data.

When the processor 10 proceeds to ACT 9 and the user restriction is in the set state, the processor 10 determines YES in response to the presence of the management data including the field FBA in which the user ID of the logged-in user is set, and proceeds to ACT 12.

In ACT 12, the processor 10 checks whether a cancellation condition for the user restriction is satisfied. The processor 10 checks whether the “period (user)” in the setting file FIA has elapsed. The specific processing of this confirmation may be substantially similar to the processing illustrated in ACT 7, for example. If it is determined that the cancellation condition of the user restriction is satisfied, the processor 10 determines YES and proceeds to ACT 13.

In ACT 13, the processor 10 cancels the user restriction related to the current error. For example, the processor 10 deletes the management data found in ACT 9 from the data record REA.

After the user restriction is set in ACT 11 or after the user restriction is cancelled in ACT 13, the processor 10 proceeds to ACT 14 (see FIG. 6) in either case. When the processor 10 determines NO in ACT 10 since the setting condition of the user restriction is not satisfied, the processor 10 passes ACT 11 and proceeds to ACT 14 (see FIG. 6). When the processor 10 determines NO in ACT 12 since the cancellation condition of the user restriction is not satisfied, the processor 10 passes ACT 13 and proceeds to ACT 14 in FIG. 6.

In ACT 14, the processor 10 checks whether the machine restriction is set. The specific processing of this confirmation may be substantially similar to the processing illustrated for ACT 4, for example. If the processor 10 determines NO (the machine restriction is not set), the processor 10 proceeds to ACT 15.

In ACT 15, the processor 10 checks whether a user restriction has been set with respect to the error identified by the error code acquired in ACT 1. The specific processing of this confirmation may be substantially similar to the processing illustrated for ACT 9, for example. If the processor 10 determines NO (the user restriction is not set), the processor 10 proceeds to ACT 16.

That is, if neither a machine restriction nor a user restriction has been set, the processor 10 proceeds to ACT 16.

In ACT 16, the processor 10 causes, for example, the control panel 13 to display a first error screen. The first error screen is a screen for notifying the user of the occurrence situation of the error and notifying the user of the guidance using the web service.

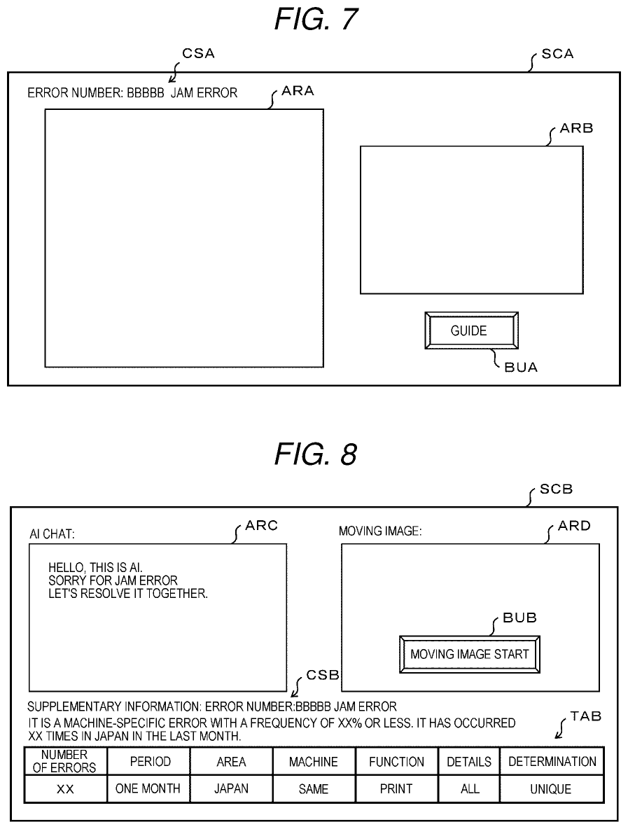

FIG. 7 is a diagram showing an example of a first error screen SCA.

The first error screen SCA includes a character string CSA, display areas ARA and ARB, and a button BUA.

The character string CSA represents the error code and an error name in characters (e.g., text). The display area ARA is an area for displaying an image to be guided with respect to a handling of the error based on the data stored in advance in the auxiliary storage unit 12. The display area ARB is an area for displaying an image for notifying the user about the guidance using the web service. The data representing the image to be displayed in the display area ARB may be stored in the auxiliary storage unit 12 in advance or may be acquired from the cloud server 4. Alternatively, the data may be generated by the processor 10 according to a predetermined rule. The button BUA is a graphical user interface (GUI) element for the user to instruct the execution of the guidance using the web service.

In the first error screen SCA shown in FIG. 7, some images are actually displayed in the display areas ARA and ARB, but are not shown in the figure. For example, the processor 10 displays, in the display area ARA, an image for notifying the user of an occurrence location, a cause, a resolving method, and the like of the error whose error code is “BBBBB”. For example, if the setting file FIA is in the state illustrated in FIG. 3, the processor 10 displays, in the display area ARB, an image for notifying the user that the guidance by the AI chat and the moving image can be used, in response to the setting item referred to as the “AI chat” and the setting item referred to as the “moving image” being valid for the category “solution means”.

In ACT 17 in FIG. 6, the processor 10 checks whether the error is resolved. If the processor 10 cannot confirm the error has been resolved, the processor 10 determines NO and proceeds to ACT 18.

In ACT 18, the processor 10 checks whether the execution of the guidance using the web service is requested. If not, the processor 10 determines NO and returns to ACT 17.

Thus, in ACT 17 and ACT 18, the processor 10 waits for the error to be resolved or the execution of the guidance using the web service to be requested.

If it can be confirmed that the error has been resolved by the scan unit 14, the print unit 15, or the facsimile unit 16, for example, the processor 10 determines YES in ACT 17 and ends the error processing.

If the execution of the guidance using the web service is requested by a predetermined operation such as touching the button BUA by the first error screen SCA, the processor 10 determines YES in ACT 18 and proceeds to ACT 19.

In ACT 19, the processor 10 causes, for example, the control panel 13 to display a guidance screen. The guidance screen is a screen for providing the guidance using the web service to the user.

FIG. 8 is a diagram showing an example of a guidance screen SCB.

The guidance screen SCB includes display areas ARC, ARD, a character string CSB, and a table TAB.

The display area ARC is an area for displaying an image for the guidance by an AI chat function provided as the web service. The display area ARD is an area for displaying an image for the guidance by a moving image reproduction function provided as the web service. In an initial state, the display area ARD displays a button BUB as a GUI element for the user to instruct a start of the moving image as shown in FIG. 8. In the character string CSB, a supplementary explanation of the error is represented by characters (e.g., text). The table TAB shows conditions for counting the number of errors.

In ACT 20, the processor 10 checks whether an operation for some request related to the web service has been performed. If not, the processor 10 determines NO and proceeds to ACT 21.

In ACT 21, the processor 10 checks whether the error has been resolved. If not, the processor 10 determines NO and returns to ACT 20.

Thus, in ACT 20 and ACT 21, the processor 10 waits for the operation to be performed or the error to be resolved.

For example, if the operation for some request related to the web service, such as touching the button BUB on the guidance screen SCB, is performed, the processor 10 determines YES in ACT 20 and proceeds to ACT 22.

In ACT 22, the processor 10 requests the cloud server 4 to perform a service according to the operation. If an operation for inputting and transmitting, for example, a question regarding the AI chat is performed, the processor 10 requests the cloud server 4 to answer the question. The cloud server 4 responds to the answer to the question. The cloud server 4 may instruct another AI chat server to answer. For example, if the button BUB is touched, the processor 10 requests the cloud server 4 to start playing the moving image. In response to this request, the cloud server 4 transmits moving image data as a response to the multifunction device 1 of the request source via the communication network 2, for example. The cloud server 4 may instruct another moving image distribution server to transmit operation data.

In ACT 23, the processor 10 waits for a response to the request in ACT 22. If a response has been made, the processor 10 determines YES and proceeds to ACT 24.

In ACT 24, the processor 10 updates the guidance screen according to the response. For example, the processor 10 updates the image indicated in the display area ARC so as to include the character string representing the answer to the question. Further, for example, the processor 10 changes the display area ARD to a state in which the moving image is reproduced according to the transmitted moving image data. Thereafter, the processor 10 returns to a standby state of ACT 20 and ACT 21.

Thus, by the processor 10 executing processing based on the error processing program PRA, processor 10 functions as a guide unit and an allowable unit.

If it is confirmed that the error is resolved, the processor 10 determines YES in ACT 21 and ends the error processing.

As described above, if neither the machine restriction nor the user restriction has been set for the error, the processor 10 executes the guidance using the web service related to the error.

However, if it is determined that the machine restriction has been set for the error that occurred, the processor 10 determines YES in ACT 14, or if it is determined that the user restriction has been set for the error that occurred, the processor 10 determines YES in ACT 15. In either case of a machine or user restriction being in place, the process proceeds to ACT 25.

In ACT 25, the processor 10 causes, for example, the control panel 13 to display a second error screen. The second error screen is a screen for notifying the user regarding the error that has occurred.

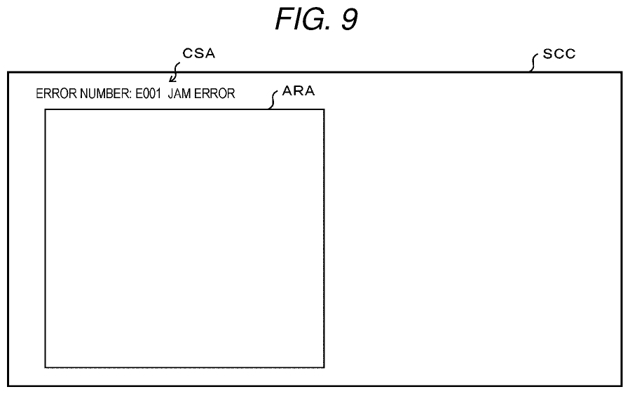

FIG. 9 is a diagram showing an example of a second error screen SCC. In FIG. 9, the same elements as those included in the first error screen SCA (shown in FIG. 7) are denoted by the same reference numerals.

In this example, the second error screen SCC is a screen obtained by omitting the display area ARB and the button BUA from the first error screen SCA.

That is, in the second error screen SCC, the user is not notified of the guidance related to use of the web service for error resolution.

Thus, by the processor 10 executing the information processing based on the error processing program PRA, the processor 10 (or computer, device, or the like incorporating the processor 10) functions as a display unit causing a display device provided in the control panel 13 to display the first error screen or the second error screen. The first error screen and the second error screen are different from each other in that the second error screen does not provide guidance related to the web service or otherwise indicate the web service is an option.

In ACT 26, the processor 10 waits for the error to be resolved. That is, unlike the standby state of ACT 17 and ACT 18, the processor 10 does not wait for a guide request. If it is confirmed that the error is resolved by the scan unit 14, the print unit 15, or the facsimile unit 16, for example, the processor 10 determines YES in ACT 26 and ends the error processing.

As described above, if a machine restriction or a user restriction is set for the error that occurred, the processor 10 does not execute the guidance associated with using the web service related to the error. That is, at this time, the use of the guidance using the web service is restricted (not available to the user via the control panel 13).

As described above, according to the multifunction device 1, in the case of the specific example based on the settings as shown in FIG. 3 which is representative of a setting file FIA, the use of the guidance using the web service can be allowed or restricted in accordance with various circumstances in which the same error type has occurred in the multifunction device 1 within the last month in Japan for multifunction devices 1 whose machine attributes are the same. Therefore, it is possible to prevent the web service from being used without restriction. Provision of error resolution guidance related to the error by the web service has merits such as increasing the probability of resolving the error, but also has demerits such as requiring time to exchange chats or providing the moving image, and possibly taking a longer time to resolve the error. Therefore, since it is possible to prevent the web service from being used without restriction, it is possible to limit the possible demerits from excessive use of the web service.

Further, according to the multifunction device 1, when the user is logged in, the use of the guidance using the web service can be allowed or restricted in accordance with the tracked past occurrence (s) of the same error occurring for the user. Therefore, the use of the web service can be restricted according to whether the user (user ID) has recently or previously experienced and resolved the same error type or whether the user (user ID) has not recently or previously experienced the same error type.

As a result, it is possible to prevent the user who is already accustomed to handling the error from unnecessarily using the web service (e.g., by habit, accident, or the like). As a result, in addition to being able to prevent the influence of the above demerits from being large, it is possible to prevent an excessive usage fee from being generated when, for example, the web service is provided as a charged service. Being able to prevent an excessive usage fee from being generated also has merits for a provider of the web service since it is possible to avoid various troubles associated with customers receiving large amount usage fee billings either unexpectedly or consistently beyond perceived service value. That is, it is possible to improve customer satisfaction related to the use of the web service.

In addition, when the guidance using the web service is restricted, the multifunction device 1 sets the screen for notifying the user of the occurrence of the error as the second error screen SCC, and does not display the guidance regarding the web service. As a result, for the user who is accustomed to handling the occurred error and does not require the guidance by the web service, it is possible to make the display easier for the user by display of the (visually) simpler second error screen SCC.

In addition, the multifunction device 1 of the present embodiment reviews the past occurrences of the error or not based on a condition that can be set in the settings represented in the setting file FIA. Therefore, by changing the setting file FIA, the condition (s) for determining whether or not to review the past occurrences of the error can be changed as desired. Accordingly, it is possible to appropriately determine a condition of the restriction of web service use in accordance with a usage environment of each multifunction device 1 individually.

Further, the multifunction device 1 of the present embodiment automatically cancels a machine restriction and a user restriction when certain cancellation conditions are satisfied. That is, the multifunction device 1 continues the machine restriction and the user restriction until these cancellation conditions are satisfied, and thus displays the second error screen SCC for some period of time after a restriction setting is made. As a result, the user can avoid annoying feelings caused by the first error screen SCA being displayed repeatedly.

The example embodiment can be variously modified.

For example, the error notification in ACT 2 (in FIG. 5) may not be performed, and the error notification to the server 3 may be performed at another time (which may be set arbitrarily). In this case, notifications related to a plurality of errors may be collectively performed at one time. Such an error notification may be performed in response to a request from the server 3 or at regular intervals or the like.

The acquisition of the number of errors in ACT 3 in FIG. 5 may be realized by acquiring the number of errors from the cloud server 4 as the response to a request from the multifunction device 1 to the cloud server 4. If such an embodiment is employed, the number of errors need not necessarily be acquired during the machine restriction state and the user restriction state.

Either of the machine restriction or the user restriction may be canceled or overridden, for example, in response to a cancellation instruction by the user.

Just one of the machine restriction or the user restriction may be applied after a setting condition has been satisfied. That is, for example, the processor 10 may proceed from ACT 3 to ACT 5 without performing ACT 4, ACT 7, ACT 8, ACT 9, ACT 12, and ACT 13 in FIG. 5, then proceed from ACT 6 to ACT 10 when the processor 10 determines NO in ACT 5.

The setting file FIA can be stored in a storage device accessible from a plurality of multifunction devices 1, such as the storage device being provided in the server 3 or the cloud server 4, and may be shared by the plurality of multifunction devices 1.

Counting of the number of errors may be performed by the server 3 only for the occurrence situation of the error managed by the server 3.

The counting of the number of errors may be performed by the processor 10 only for the occurrence situation of the error in the particular multifunction device 1 provided with the processor 10.

An evaluation of a past occurrence circumstances of the error may be performed, for example, based on another optional index value such as an occurrence frequency of the error over a certain period of time.

Some or all of the functions implemented by the processor 10 as the information processing may be implemented by hardware, such as a logic circuit, that executes processing without a software program. Further, each of the functions described above with respect to a processor 10 may be implemented by combining software instructions executed by a processor or the like with the dedicated hardware such as a logic circuit or the like.

While certain embodiments disclosed here have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. These embodiments and modifications thereof are included in the scope and spirit of the disclosure and are also included in the disclosure described in the claims and an equivalent scope thereof.

What is claimed is:

1. A multifunction device, comprising:
a display unit with a display screen;
a device unit configured to generate an error code when an error in the device unit occurs; and
a processor configured to:
acquire the error code from the device unit,
transmit an error notification including the error code to an external apparatus,
receive a counted number of errors from the external apparatus, and
select an error resolution screen to be displayed on the display screen based on the received counted number of errors.

2. The multifunction device according to claim 1, wherein the processor is further configured to control the display unit to display the selected error screen on the display screen.

3. The multifunction device according to claim 1, wherein the processor selects the error resolution screen based on a comparison of the counted number of errors to a stored threshold value associated with the error code.

4. The multifunction device according to claim 1, wherein in the counted number of errors is the accumulated number of errors occurring in a plurality of multifunction devices associated with the external apparatus.

5. The multifunction device according to claim 1, wherein
the processor is further configured to acquire a user ID corresponding to a user logged in to the multifunction device when the error in the device unit occurs, and
the counted number of errors is the accumulated number of errors associated with the user ID.

6. The multifunction device according to claim 1, wherein the processor selects between a first error resolution screen providing access to a web-based error resolution service and a second error resolution screen not providing access to the web-based error resolution service.

7. The multifunction device according to claim 6, wherein the web-based error resolution service includes at least one of a video guide and an artificial intelligence chat system.

8. The multifunction device according to claim 1, wherein the device unit is one of a printer, a scanner, or a facsimile device.

9. The multifunction device according to claim 1, wherein the error notification includes information indicating a device unit operating setting that was set when the error occurred.

10. An error resolution system for multifunction devices, the system comprising:
a plurality of multifunction devices; and
a server connected to the plurality of multifunction devices, wherein
each multifunction device includes:
a display unit with a display screen;
a device unit configured to generate an error code when an error in the device unit occurs; and
a processor configured to:
acquire the error code from the device unit,
transmit an error notification including the error code to the server,
receive a counted number of errors from the server, and
select an error resolution screen to be displayed on the display screen based on the received counted number of errors, and
the server is configured to:
receive error notifications from the plurality of multifunction devices,
cause error notifications to be stored in an error history database, and
calculate the counted number of errors in response to the error notifications.

11. The error resolution system according to claim 10, further comprising:
a cloud-based server configured to provide web-based services for error resolution to the plurality of multifunction devices upon user request made via the error resolution screen.

12. The error resolution system according to claim 11, wherein the web-based services include at least one of a video guide and an artificial intelligence chat system.

13. A multifunction device control method for error resolution, the control method comprising:
acquiring the error code from a device unit of a multifunction device after an error occurs in the device unit;
transmitting an error notification including the error code to an external apparatus across a network connection;
receiving a counted number of errors from the external apparatus via the network connection; and
selecting an error resolution screen to be displayed on a display screen of the multifunction device based on the received counted number of errors.

14. The control method according to claim 13, wherein the error resolution screen is selected based on a comparison of the counted number of errors to a stored threshold value associated with the error code.

15. The control method according to claim 13, wherein in the counted number of errors is the accumulated number of errors occurring in a plurality of multifunction devices associated with the external apparatus.

16. The control method according to claim 13, further comprising:
acquiring a user ID corresponding to a user logged in to the multifunction device when the error in the device unit occurs, wherein
the counted number of errors is the accumulated number of errors associated with the user ID.

17. The control method according to claim 13, wherein the error resolution screen to be displayed is either a first error resolution screen providing access to a web-based error resolution service or a second error resolution screen not providing access to the web-based error resolution service.

18. The control method according to claim 17, wherein the web-based error resolution service includes at least one of a video guide and an artificial intelligence chat system.

19. The control method according to claim 13, wherein the device unit is one of a printer, a scanner, or a facsimile device.

20. The control method according to claim 13, wherein the error notification includes information indicating a device unit operating setting that was set when the error occurred.
